(19) United States
(12) Patent Application Publication
(10) Pub. No.: US 2025/0196376 A1
(43) Pub. Date: Jun. 19, 2025

(54) DEVICE FOR MANIPULATING ITEMS CONTAINED IN A GLOVE BOX WHILE FORMING A DOUBLE SEALED WALL, AND ASSOCIATED GLOVE BOX

(71) Applicant: COMMISSARIAT A L'ENERGIE ATOMIQUE ET AUX ENERGIES ALTERNATIVES, Paris (FR)

(72) Inventors: Coline NANTERMOZ, Gif-sur-Yvette Cedex (FR); Yann PERROT, Gif-sur-Yvette Cedex (FR)

(73) Assignee: COMMISSARIAT A L'ENERGIE ATOMIQUE ET AUX ENERGIES ALTERNATIVES, Paris (FR)

(21) Appl. No.: 18/969,568

(22) Filed: Dec. 5, 2024

(30) Foreign Application Priority Data
Dec. 14, 2023 (FR) 2314236

(51) Int. Cl. B25J 21/02; B25J 1/10

(52) U.S. Cl. CPC B25J 21/02; B25J 1/10

(57) ABSTRACT

A device for manipulating items contained in a glove box while forming a double scaled wall, and associated glove box. The scaling of the open end of a protective sleeve can be achieved when a robotic arm or a slave arm is inserted into it, within a glove box.

### TECHNICAL FIELD

The present invention relates to the field of glove boxes, and more particularly to devices for manipulating items contained in a glove box.

### PRIOR ART

A glove box is a sealed enclosure having at least one transparent wall, the sealed enclosure being adapted for the manipulation of substances and objects in a controlled atmosphere. Glove boxes are particularly useful when the substances or objects to be manipulated are harmful to humans or are subject to contamination, as in the case of the nuclear, chemical, pharmaceutical and medical fields, for example.

A glove box comprises at least one through opening formed in one of its walls, in which a flexible sleeve is designed to be sealingly mounted, for the purpose of accessing the products and materials present inside the glove box. The flexible sleeve ensures that a controlled atmosphere is maintained within the enclosure, by forming a sealed barrier through which the items contained in the enclosure can be manipulated.

The flexible sleeve is usually a glove for accommodating an operator's hand.

FIG. 1 shows part of a glove box 1 comprising a through opening 2 in which a glove 3 is sealingly mounted. The glove 3 is mounted in the opening 2 by means of an enclosure ring 4 fixed to the wall 5 delimiting the enclosure by clamping, using a screw and nut system 6.

A support ring 7 is mounted removably on the enclosure ring 4. The end of the glove 3 is provided with a bead 8 which is housed between the support ring 7 and the enclosure ring 4. The support ring 7 compresses the bead 8 against the enclosure ring 4, thus ensuring the sealing of the assembly. Also known from the prior art are gloves fixed in the opening of a glove box by means of a support ring and an enclosure ring, said gloves having no beads, and sealing being ensured by gaskets.

An immobilizing ring 9 enables the support ring 7 to be immobilized relative to the enclosure ring 4.

The manipulation of items contained in a glove box using a glove, such as that illustrated in FIG. 1, remains dangerous for an operator.

This is because there is a risk of accidents that may break the seal of the glove box and consequently expose the operator to harmful items contained therein. Notably, there is a risk of puncturing the glove during manipulation.

Although the glove box is opaque to alpha and beta radiation, gamma radiation may be transmitted through the glove. Thus glove boxes using a glove as a flexible sleeve do not provide optimal protection for the manipulation of radioactive items by an operator.

Furthermore, some tasks requiring the manipulation of items contained in a glove box by an operator are difficult, for example preventive maintenance and/or cleaning tasks. The performance of these difficult tasks by an operator reduces the working time available for other tasks having a higher added value.

In order to overcome at least some of the aforesaid drawbacks, a robotic arm or a remote manipulator may be used for the manipulation of items contained in a glove box.

However, standard glove boxes are not suitable for the installation of a robotic arm entirely within their enclosure. In particular, the interior of glove boxes is usually cramped and may be encumbered with numerous objects. Furthermore, a robotic arm may be unsuitable for withstanding the confined atmosphere of glove boxes, which may, notably, be corrosive, dusty and/or radioactive. Moreover, the maintenance of a robotic arm arranged entirely within a glove box would be very complicated.

It is therefore preferable to place the robotic arm outside the glove box and to insert it into the flexible sleeve, which forms a protective sleeve for the robotic arm if necessary, in order to manipulate the items inside the glove box.

Similarly, in view of the operation of a remote manipulator, to meet the same manipulation requirements, a master arm of the remote manipulator must be arranged outside the glove box and a slave arm must be inserted into the flexible sleeve, which forms a protective sleeve for the slave arm if necessary.

Like a glove, the protective sleeve ensures that a controlled atmosphere is maintained inside the glove box, by forming a sealed barrier between the interior of the box and the robotic arm or the remote manipulator. The protective sleeve also protects the robotic arm or remote manipulator from the confined atmosphere. The mounting of the protective sleeve in an opening of a glove box is usually similar to that of a glove, for example the mounting of the glove 3 illustrated in FIG. 1.

Additionally, even if a robotic arm or remote manipulator is used, there is always a risk of puncturing the protective sleeve. In some cases, the confinement of the controlled atmosphere of the glove box is no longer ensured. Furthermore, the breaking of the seal of a protective sleeve may remain undetected for a long time, notably a longer time than the time for detecting the breaking of the seal of a glove. In fact, the operator himself may notice a puncturing of the glove during a manipulation, or the detection may take place in the course of an inspection, when the operator leaves the working area containing the glove box. These methods of leak detection are unsuitable for a protective sleeve into which a robotic arm or a slave arm of a remote manipulator is inserted over a period of several days, since in this case they cannot be used sufficiently frequently.

Also known are sealed feedthrough systems used in shielded cells, notably in the nuclear industry. These systems are used, for example, for transmission between the master arm and the slave arm of a remote manipulator. However, these systems are unsuitable for glove boxes, because they require a thick wall that can withstand large mechanical forces, which is not the case for the walls of a glove box.

Consequently there is a need to improve devices for manipulating items contained in a glove box, notably by overcoming the aforementioned drawbacks.

In particular, there is a need for such a device which provides the best confinement of the controlled atmosphere of the glove box.

The object of the invention is to provide at least a partial response to this need or needs.

### SUMMARY OF THE INVENTION

To this end, the invention relates to a device for manipulating items contained in a glove box, comprising:
an enclosure ring adapted to be fixed to the edge of a through opening formed in a wall (16) of the glove box,
a sealed protective sleeve comprising an open end,
a support ring on which the sealed protective sleeve is sealingly mounted, the support ring being adapted to be fitted into the enclosure ring in such a way as to sealingly fix the protective sleeve to the enclosure ring,
a robotic arm or a slave arm of a remote manipulator comprising a plug, the robotic arm or the slave arm being adapted to be inserted into the protective sleeve with the plug which sealingly plugs the open end of the protective sleeve.

Preferably, the device comprises an immobilizing ring to lock the support ring when it is fitted into the enclosure ring.

Preferably, the robotic arm or the slave arm is mounted on a support for absorbing forces exerted by the robotic arm or the slave arm, the support being adapted to be fixed to the ground, to a partition of a structure, such as a wall, or to the ceiling.

Preferably, the device comprises a pressure sensor designed to be arranged in the protective sleeve plugged by the plug in order to detect a change of pressure in the sealed volume delimited by the protective sleeve and the plug.

Preferably, the plug comprises a base, a sealed collar fixed sealingly around the base, and a means for sealingly fixing the collar to the support ring.

Preferably, the collar is made of flexible polymer, preferably polyurethane or polyvinyl chloride.

Preferably, the collar comprises an inner bead housed and compressed in a groove formed in the base.

Preferably, the fixing means is a support hoop on which the collar is mounted, the support hoop being adapted to be fitted into the support ring in such a way as to fix the collar sealingly to the support ring.

Preferably, the support hoop is adapted to compress the collar against the support ring so as to provide the seal between the collar and the support ring, the collar preferably comprising an outer bead housed in a groove formed in the support hoop and adapted to be compressed against the support ring.

The invention also proposes a glove box comprising:
a through opening formed in one of its walls,
a device according to the present invention, the enclosure ring being fixed to the edge of the through opening and the support ring being fitted into the enclosure ring, thus sealingly fixing the sealed protective sleeve to the enclosure ring.

Preferably, the box comprises a spacer adapted to be assembled, preferably by a bayonet fixing, with the support hoop and the base of the plug of the device so as to maintain a radial separation, preferably constant, between the support hoop and the base.

Preferably, the box comprises an insertion tube for guiding the plug in translation when it is inserted into the sealed protective sleeve, the insertion tube preferably being configured to keep the plug concentric with the support ring.

Preferably, the insertion tube comprises a mechanism for exerting a pushing force on the plug, the mechanism preferably converting a rotary movement of a handwheel into a translational movement.

The present invention therefore essentially consists in proposing the sealing of the open end of a protective sleeve when a robotic arm or a slave arm is inserted into it, within a glove box.

Thus the device according to the invention makes it possible to manipulate the items contained in a glove box while forming a double sealed wall between the controlled atmosphere of the glove box and the external environment. The first sealed wall is formed by the protective sleeve, and the second sealed wall is formed by a plug which sealingly plugs the open end of the protective sleeve.

Consequently, if the seal of the protective sleeve is broken, the plug still preserves the confinement of the controlled atmosphere of the glove box.

Contrary to the prior art devices, the confinement of the controlled atmosphere is therefore not dependent on a single wall which may be relatively fragile and subject to a risk of serious puncturing. Furthermore, the wall formed by the plug is not subject to the risks of puncturing and/or tearing; notably, it is not placed in contact with the manipulated items.

The items contained in a glove box may be manipulated by the robotic arm or the slave arm of the device according to the invention. This avoids the risks and problems associated with manipulation by an operator using a glove.

Furthermore, advantageously, with the device according to the invention, the mechanical forces of the robotic arm or the slave arm are not borne by a wall of the glove box.

In addition, the device is suitable for existing glove boxes and therefore requires no modification of said boxes for the installation of the device. Notably, the enclosure ring, the support ring and the protective sleeve may be similar to existing types for the assembly of a protective sleeve in the opening of a glove box. In particular, they may conform to the existing standards as set out in the ISO 11933-1 standard.

The device according to the invention is simple and quick to install on a glove box. Notably, the device is suitable for the replacement of a worn glove or protective sleeve with a new protective sleeve, without breaking the confinement of the controlled atmosphere.

### BRIEF DESCRIPTION OF THE DRAWINGS

Other advantages and features will be more readily apparent from a perusal of the detailed description, provided by way of non-limiting illustration, with reference to the following figures:

FIG. 1 is a schematic sectional view of the assembly, according to the prior art, of a glove in an opening of a glove box.

FIG. 2 is a schematic sectional view of a device according to the invention, mounted in an opening of a glove box.

FIGS. 3 to 7 are schematic sectional views showing different steps of a method for installing a protective sleeve of a device according to the invention, in a glove box.

FIGS. 8 to 14 are schematic sectional views showing different steps of a method for installing a robotic arm of a device according to the invention, in the protective sleeve installed according to FIGS. 3 to 7.

### DETAILED DESCRIPTION

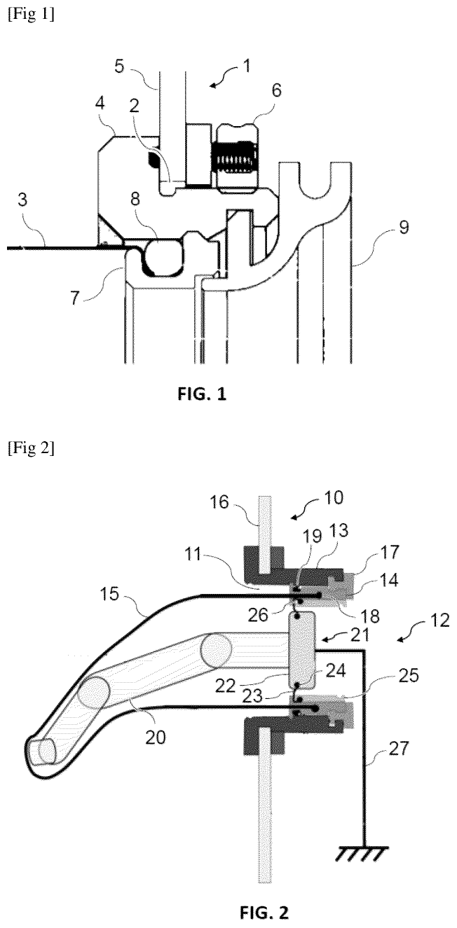

FIG. 1 has already been described in the preamble and will therefore not be described below.

For clarity, the different elements of the figures are shown on a variable scale; the actual dimensions of the different parts are not necessarily preserved.

FIG. 2 shows a glove box 10 comprising a through opening 11 and a device 12 according to the invention for the manipulation of items contained in the glove box 10, which is mounted sealingly through the through opening.

The device 12 comprises an enclosure ring 13, a support ring 14 and a protective sleeve 15. The enclosure ring 13 is fixed by clamping or welding to a wall 16 of the glove box 10 around the opening 11.

The protective sleeve 15 is mounted sealingly at its open end on the support ring 14, which is itself 14 fitted sealingly into the enclosure ring 13.

The support ring 14 may be clipped into the enclosure ring 13.

The device 12 also comprises an immobilizing ring 17 which ensures that the support ring 14 fitted into the enclosure ring 13 is kept fixed.

The sealing mounting of the protective sleeve 15 in the opening 11 may conform to the existing standards according to the ISO 11933-1 standard.

For example, as shown in FIG. 2, the protective sleeve 15 may comprise a bead 18 at its open end, inserted sealingly into the support ring 14, the seal between the support ring 14 and the enclosure ring 13 then being provided by a lip seal 19 on the outer periphery of the support ring 14.

According to another example, the mounting of the protective sleeve 15 in the opening 11 may be similar to that shown in FIG. 1.

The device 12 also comprises a robotic arm 20 inserted into the protective sleeve 15 so that it can manipulate items contained in the glove box 10.

The robotic arm 20 comprises at its base a plug 21 which sealingly plugs the open end of the protective sleeve 15. The plug 21 is surrounded by the support ring 14. Thus the rest of the robotic arm 20 is housed in a sealed volume delimited between the protective sleeve 15 and the plug 21. Should the protective sleeve 15 be punctured, the seal of the robotic arm 20 in the glove box 10 is still preserved by the plug 21.

A pressure sensor may be housed in the aforementioned sealed volume, and may thus advantageously detect any leakage, thereby detecting the puncturing of the protective sleeve 15.

The plug 21 comprises a base 22, on which is mounted the rest of the robotic arm 19, and a sealed collar 23 fixed sealingly around the base 22.

The outer periphery of the collar 23 is fixed sealingly to the support ring 14.

Thus the base 22 partially plugs the open end of the protective sleeve 15 and the collar 23 sealingly closes off the space between the base 22 and the support ring 14.

The collar 23 takes the form of a hollow disk. The inner periphery of the collar 23 comprises an inner bead 24 housed and compressed in the base 22, which improves the seal of the fixing of the collar 23 around the base 20. In particular, the base 22 may comprise two plates which sandwich the inner bead 24 between them.

The plug 21 may comprise a support hoop 25 as a means of fixing the collar 23 to the support ring 14. The outer periphery of the collar 23 is fixed to the support hoop 25. Notably, the outer periphery of the collar 23 comprises an outer bead 26 housed in a groove formed in the outer periphery of the support hoop 25.

The support hoop 25 is fitted into the support ring 14 by pressing the collar 23 against the support ring 14. Notably, the support hoop 24 may be pushed into the support ring 14 and come to bear against a stop of the support ring 14 projecting toward its interior. Alternatively, the support ring 14 may comprise an inner radial groove and the support hoop 25 may comprise a rib on its outer periphery, such that the support hoop 25 is clipped into the support ring 14.

The collar 23 is sandwiched between the stop and the support hoop 24.

The outer bead 26 is compressed against the inner wall of the support ring 14 by the support hoop 25. Thus the outer bead 26 improves the seal of the fixing of the collar 23 to the support ring 14.

The robotic arm 20 is mounted on a support 27, independent of the glove box 10 and adapted to cause the forces exerted by the robotic arm 20 to be absorbed by the ground. Thus the robotic arm 20 transmits no mechanical force to the wall 16 of the glove box 10.

This support 27 may be adapted to be fixed to the ground, to a partition of a structure, such as a wall, or to the ceiling.

This support 27 may also be movable relative to the glove box 10; for example, the support 27 may comprise castors, preferably castors with brakes.

The support 27 may comprise an elevating means for moving the robotic arm 20 vertically relative to the ground and to the glove box 10. Thus the height of the robotic arm 20 can be adjusted according to the height of the opening 11 relative to the ground. This elevating means may, for example, comprise a telescopic column and/or a jack.

The support 27 may comprise a fixing means configured for fixing the support 27 removably to the frame of the glove box 10.

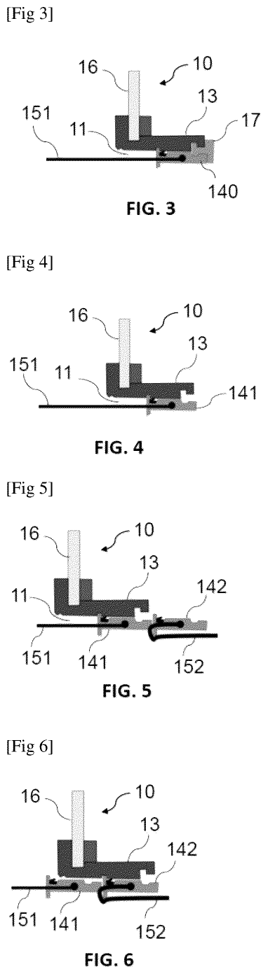

FIGS. 3 to 7 show different steps of a method for installing a protective sleeve 152 of a device 12 according to the invention in a glove box 10. The method for installing the protective sleeve 152 in a glove box 10 is similar to the standard procedures according to the ISO 11933-1 standard.

The new protective sleeve 152 is installed to replace another protective sleeve 151 which has become worn, or a glove 3.

Thus, as shown in FIG. 3, a worn protective sleeve 151 to be replaced is mounted sealingly in an opening 11 of a glove box 10.

FIG. 4 shows the withdrawal of the immobilizing ring 17 for the purpose of proceeding to replace the worn protective sleeve 151.

This withdrawal is followed by the insertion of the new protective sleeve 152 by fitting a new support ring 142 into the enclosure ring 13, the new support ring 142 pushing the old support ring 141 until it falls into the glove box 10. This insertion step, shown in FIGS. 5 and 6, enables the confinement of the controlled atmosphere to be maintained in the glove box 10.

The insertion may be performed using an insertion tube, not shown here. An insertion tube is also called an “ejection gun” in the technical field.

The support ring 142 to be inserted and the new protective sleeve 152 are installed in the insertion tube. The insertion tube is locked to the enclosure ring 13, and the insertion tube is then screwed, thereby inserting the support ring 142 into the enclosure ring 13. When the insertion tube has reached a stop, the insertion of the new support ring 142 and the new protective sleeve 152 is complete. The insertion tube may be configured so that, at the end of its travel, in the stop position, the support ring 142 is clipped into the enclosure ring 13.

The insertion tube is then unscrewed from the enclosure ring 13 and removed.

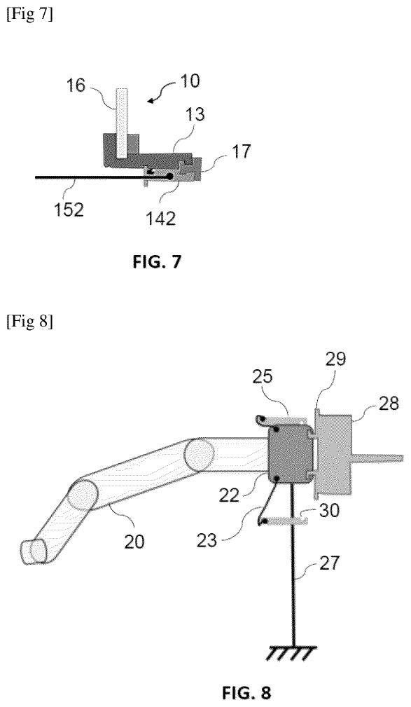

When the support ring 142 has been fitted into the enclosure ring 13, the immobilizing ring 17 is re-installed, thus locking the support ring 142 in the enclosure ring 13, as shown in FIG. 7.

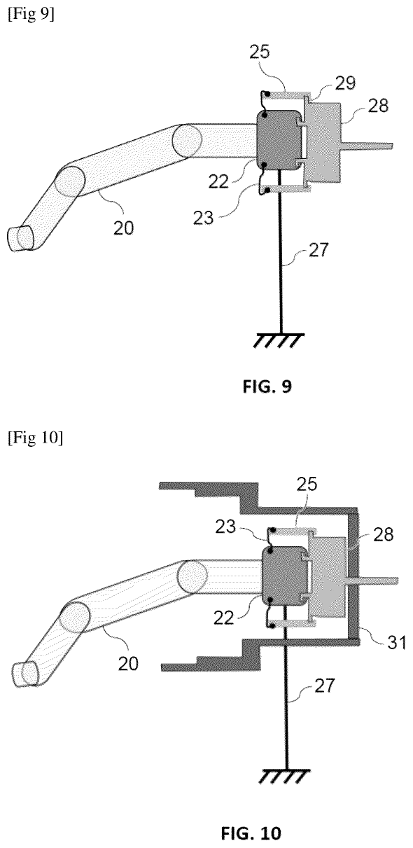

FIGS. 8 to 14 show different steps of a method for installing a robotic arm 20 in a protective sleeve 15 of a device 12 according to the invention.

Initially, as shown in FIG. 8, the support hoop 25 is connected to the base 22 by the collar 23 only. The support hoop 25 therefore hangs against the base 22, bearing on the latter. The distance between the support hoop 25 and the base 22 is then not constant.

In order to maintain a constant radial separation between the support hoop 25 and the base 22, thus facilitating the fitting of the support hoop 25 into the support ring 14, the support hoop 25 is fixed to a spacer 28.

For this purpose, the spacer 28 may comprise pins 29 and the support hoop 25 may comprise grooves 30 formed within it, the pins 29 and the grooves 30 forming a bayonet fixing system for fixing the support hoop 25 to the spacer 28.

The spacer 28 is arranged concentrically relative to the base 22. The support hoop 25 then exhibits a constant radial separation from the base 22, and the collar 23 is uniformly stretched.

The spacer 28 may also be fixed to the base 22, by a bayonet fixing for example. Alternatively, the spacer 28 may not be fixed to the base 22, and may, for example, take the form of a sleeve surrounding the base 22.

The mounting of the spacer 28 is followed by the placing of a plug 21 and the spacer 28 in an insertion tube 31, as shown in FIG. 10.

The insertion tube 31 is then positioned around the enclosure ring 13, bearing against the enclosure ring 13 or against the wall 16 of the glove box 10.

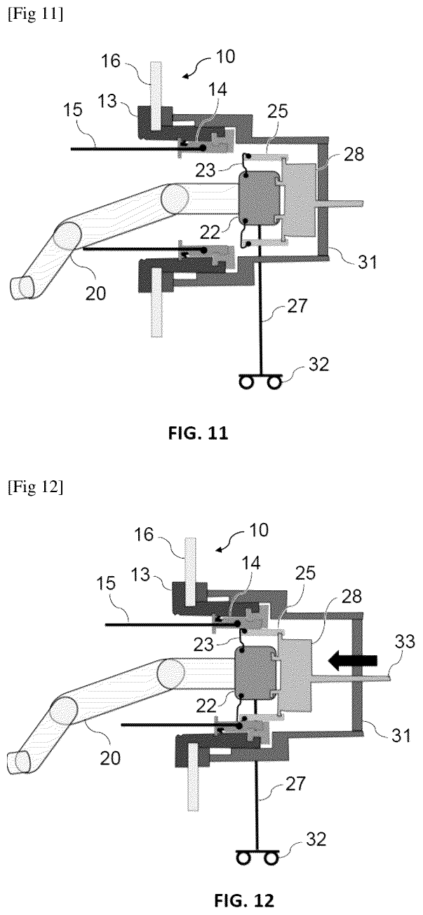

FIG. 11 shows the insertion tube 31 positioned around the enclosure ring 13. The plug 21 is then centered relative to the enclosure ring 13 and the support ring 14. This prevents the plug 21 from pushing the support ring 14 when it is inserted into the latter.

The robotic arm 20 is inserted into the protective sleeve 15 and then the plug 21 is translated in the support ring 14 while being guided by the insertion tube 31.

FIG. 12 shows the translation of the plug 21 in the support ring 14. To facilitate the insertion of the robotic arm 20, the support 27 comprises castors 32. The plug 21 can be translated by pushing the spacer 28. Notably, the spacer 28 may comprise a threaded rod 33 to be screwed into the body of the insertion tube 31, for example by means of a handwheel which is not shown here.

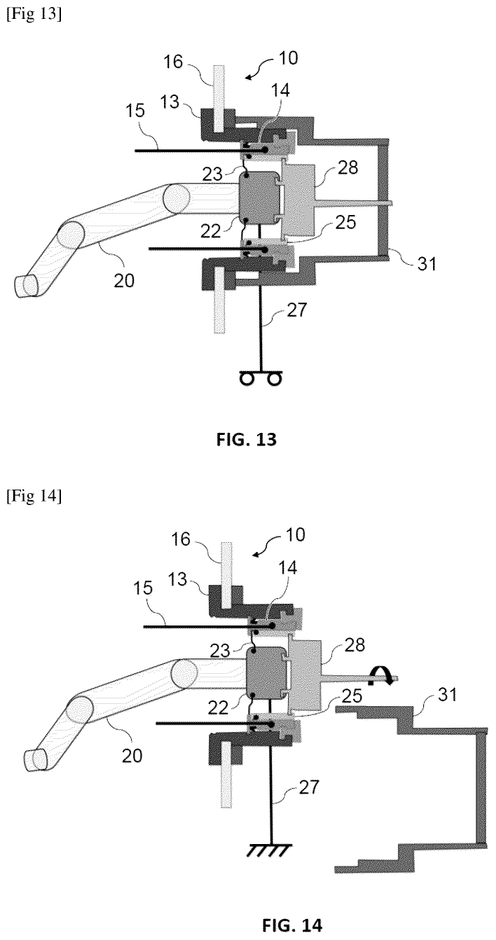

As shown in FIG. 13, the translation of the plug 21 ceases when the support hoop 25 comes to bear against an inwardly projecting stop of the support ring 14. The plug 21 then sealingly plugs the protective sleeve 15. Alternatively, the threaded rod 33 or the insertion tube 31 may comprise a stop after which the threaded rod 33 is locked and cannot be screwed farther into the insertion tube 31, thus terminating the pushing of the spacer 28.

When the robotic arm 20 has been inserted into the protective sleeve 15 with the seal provided by the plug 21, the support 27 is fixed relative to the glove box 10. For example, the support 27 may comprise a means for fixing to the frame of the glove box 10, and/or the castors 32 may comprise brakes which are applied.

The insertion tube 31 can then be removed. The spacer 28 can then also be removed, notably by rotation, for example a quarter-turn, as shown in FIG. 14.

If the protective sleeve 15 is intact and therefore still ensures the confinement of the controlled atmosphere of the glove box 10, the robotic arm 20 can be withdrawn from the protective sleeve 15 and from the inside of the glove box 10 by executing the steps of the insertion procedure described above, in reverse order.

When the robotic arm 20 has been removed, the protective sleeve 15 can be replaced with a new protective sleeve 15 or a glove 3, by a method similar to that shown in FIGS. 3 to 7.

If the protective sleeve 15 has been punctured, the confinement of the controlled atmosphere of the glove box 10 is ensured as long as the plug 21 plugs the protective sleeve 15.

If necessary, at least two methods of replacing the protective sleeve 15 may be considered.

A first method of replacement consists in pushing the assembly comprising the support ring 14, the protective sleeve 15 and the robotic arm 20 into the glove box 10, after the immobilizing ring 17 has been withdrawn. This pushing is carried out simultaneously with the fitting of the new support ring 14, on which is mounted a glove 3 or a new protective sleeve 15, into the enclosure ring 13. This first method comprises a step of disconnecting the robotic arm 20 from the support 27 before the assembly is pushed. This first method may be executed in a similar manner to the method described for FIGS. 3 to 7. Having been pushed into the glove box 10, the robotic arm 20 is considered to be a waste item that can be removed.

A second method of replacement comprises the withdrawal of the robotic arm 20 from the protective sleeve 15, followed by the replacement of the protective sleeve 15 by a method normally used for replacing a punctured glove. The robotic arm 20 can be decontaminated for re-use.

Other variants and improvements would be feasible without departure from the scope of the invention.

For example, the robotic arm 20 can be replaced with a slave arm of a remote manipulator. If necessary, the base 22 of the plug 21 can be adapted to transmit the movements of the master arm of the remote manipulator to the slave arm.

According to another example, the outer bead 26 can be inserted sealingly into the support hoop 25 and the seal between the support hoop 25 and the support ring can be provided by a lip seal surrounding the support hoop 25.

1. A device for manipulating items contained in a glove box, comprising:
an enclosure ring adapted to be fixed to the edge of a through opening formed in a wall of the glove box,
a sealed protective sleeve comprising an open end,
a support ring on which the sealed protective sleeve is sealingly mounted, the support ring being adapted to be fitted into the enclosure ring in such a way as to sealingly fix the protective sleeve to the enclosure ring,
a robotic arm or a slave arm of a remote manipulator comprising a plug, the robotic arm or the slave arm being adapted to be inserted into the protective sleeve with the plug which sealingly plugs the open end of the protective sleeve.

2. The device as claimed in claim 1, comprising an immobilizing ring to lock the support ring when it is fitted into the enclosure ring.

3. The device as claimed in claim 1, the robotic arm or the slave arm being mounted on a support for absorbing forces exerted by the robotic arm or the slave arm, the support being adapted to be fixed to the ground, to a partition of a structure, such as a wall, or to the ceiling.

4. The device as claimed in claim 1, comprising a pressure sensor designed to be arranged in the protective sleeve plugged by the plug in order to detect a change of pressure in the sealed volume delimited by the protective sleeve and the plug.

5. The device as claimed in claim 1, the plug comprising a base, a sealed collar fixed sealingly around the base, and a means for sealingly fixing the collar to the support ring.

6. The device as claimed in claim 5, the collar being made of flexible polymer.

7. The device as claimed in claim 5, the collar comprising an inner bead housed and compressed in a groove formed in the base.

8. The device as claimed in claim 5, the fixing means being a support hoop on which the collar is mounted, the support hoop being adapted to be fitted into the support ring in such a way as to fix the collar sealingly to the support ring.

9. The device as claimed in claim 8, the support hoop being adapted to compress the collar against the support ring so as to provide the seal between the collar and the support ring.

10. A glove box comprising:
a through opening formed in one of its walls,
a device as claimed in claim 1, the enclosure ring being fixed to the edge of the through opening and the support ring being fitted into the enclosure ring, thus sealingly fixing the sealed protective sleeve to the enclosure ring.

11. The glove box as claimed in claim 10, the plug of the device comprising a base, a sealed collar fixed sealingly around the base, and a means for sealingly fixing the collar to the support ring, the fixing means being a support hoop on which the collar is mounted, the support hoop being adapted to be fitted into the support ring in such a way as to fix the collar sealingly to the support ring the box comprising a spacer adapted to be assembled with the support hoop and the base so as to maintain a radial separation, between the support hoop and the base.

12. The glove box as claimed in claim 10, comprising an insertion tube for guiding the plug in translation when it is inserted into the sealed protective sleeve.

13. The glove box as claimed in claim 12, the insertion tube comprising a mechanism for exerting a pushing force on the plug.
